(19) United States
(12) Patent Application Publication
(10) Pub. No.: US 2009/0236478 A1
(43) Pub. Date: Sep. 24, 2009

(54) UNIVERSAL INSTRUMENT VEHICLE MOUNT ASSEMBLY

(75) Inventors: Thomas M. Kramer, Elmhurst, IL (US); Matthew P. Keeley, Chicago, IL (US); Robert C. Rigert, Carol Stream, IL (US); Richard T. McGinn, Winfield, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/051,051

(22) Filed: Mar. 19, 2008

(51) Int. Cl. F16M 13/00

(52) U.S. Cl. 248/122.1

(57) ABSTRACT

The instrument mount assembly of the present invention comprises a pair of spaced apart L shaped brackets having a vertical leg and a horizontal flange extending outwardly from a bottom end thereof in a first direction and a hook at a top end thereof sized and configured to securely engage over a body rail of a truck, extending outwardly from the vertical leg in a direction opposite the flange, each flange being adapted to engage an end edge of an isolation plate sized and configured to support a corresponding instrument thereon, the brackets being engaged to one another by at least one cross rail, with the entire assembly being sized and configured to compactly hold the instrument to the body rail of the truck without interfering with any truck structures proximate thereto.

### BACKGROUND OF THE INVENTION

1. Field of the Invention

The present invention relates to a mount assembly for mounting an instrument, such as an engine exhaust emissions analyzer, to a body rail of a vehicle such as a truck, near an exhaust outlet of the truck engine, in a manner where the sensitive instrument is not damaged by vibration and does not interfere with placement of other truck structures proximate thereto, such as the cab of the truck.

2. Prior Art

Manufacturers of heavy duty diesel engines must now conduct, started as a pilot program in 2005, on-board exhaust emissions tests using customer owned vehicles, typically trucks, under normal routes and routines.

No standard or industry accepted assembly presently exists for locating or mounting instruments or exhaust analyzers to a customer vehicle.

During emissions test qualification in a laboratory environment, such analyzer is usually placed inside the van body or cab of the vehicle undergoing testing, with holes being drilled through the cab for passage of tubes of the analyzer therethrough to the area of the engine exhaust outlet.

Needless to say, such accommodation is not feasible for use on a customer owned vehicle.

In some instances the analyzer is simply set on the rear frame overhang of a tractor truck near a fifth wheel gap between the cab and the trailer, which will not work if the vehicle is in motion. The cab of the truck, however, should not be used during now required on-board exhaust emissions tests using customer owned vehicles under normal routes and routines because the analyzer generates heat and minor fumes, and/or because it occupies passenger space. Thus, the need arises for the universal instrument truck mount assembly of the present invention.

### SUMMARY OF THE INVENTION

The instrument mount assembly of the present invention comprises a pair of spaced apart L shaped brackets having a vertical leg and a horizontal flange extending outwardly from a bottom end thereof in a first direction and a hook at a top end thereof sized and configured to securely engage over a body rail of a truck, extending outwardly from the vertical leg in a direction opposite the flange, each flange being adapted to engage an end edge of an isolation plate sized and configured to support a corresponding instrument thereon, the brackets being engaged to one another by at least one cross rail, with the entire assembly being sized and configured to compactly hold the instrument to the body rail of the truck without interfering with any truck structures proximate thereto.

### BRIEF DESCRIPTION OF THE DRAWINGS

FIG. 1 is a perspective view of the universal instrument truck mount assembly of the present invention.

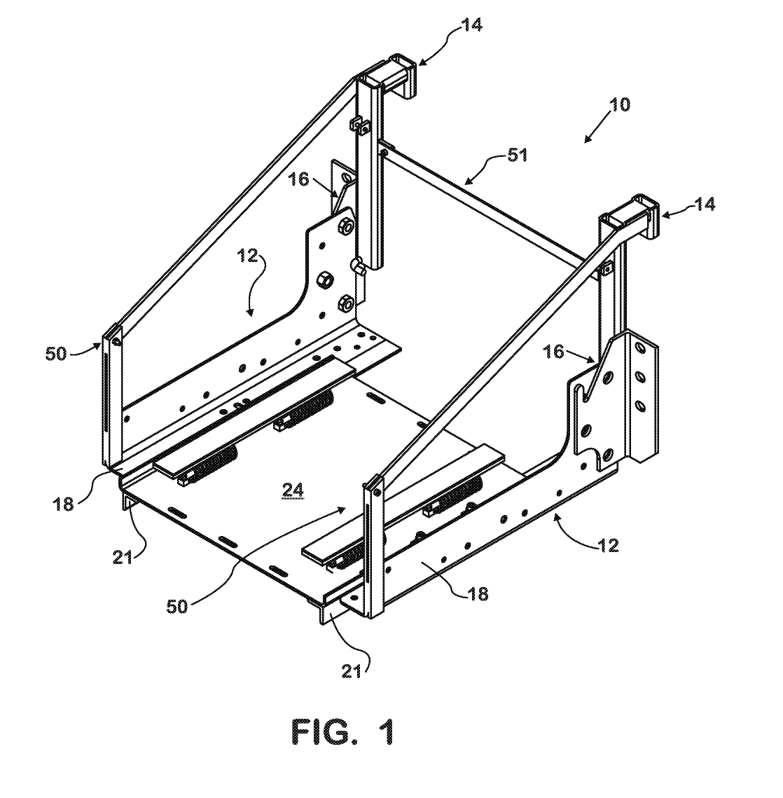

FIG. 2 is a front view of the assembly of FIG. 1.

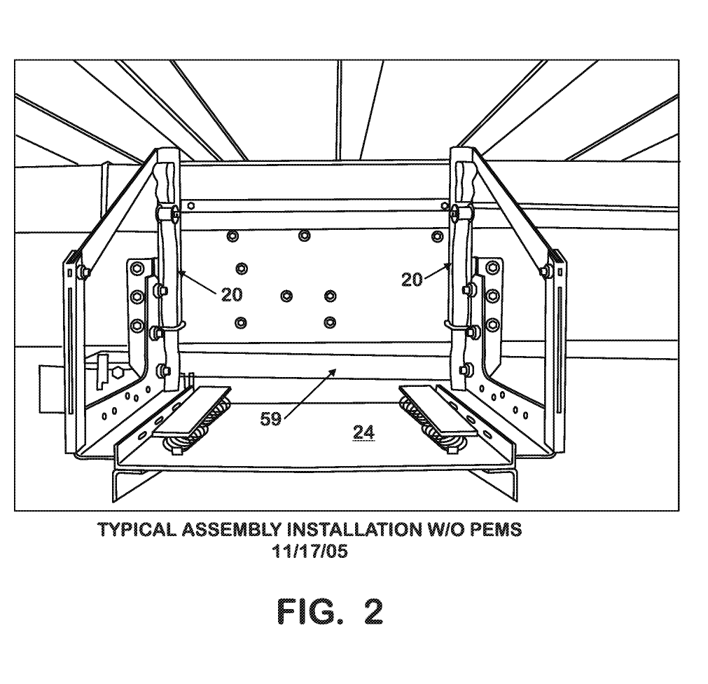

FIG. 3 is an enlarged perspective view of one strap of the assembly.

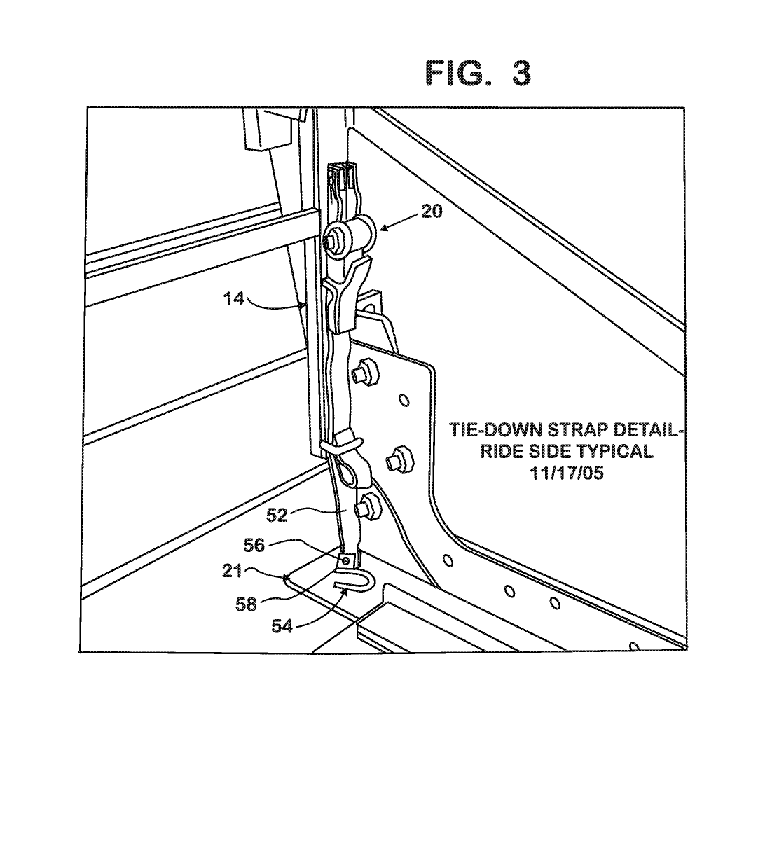

FIG. 4 is a perspective view of the assembly mounted to a chassis rail of a truck, and shows a PEMS mounted thereon and supported thereby.

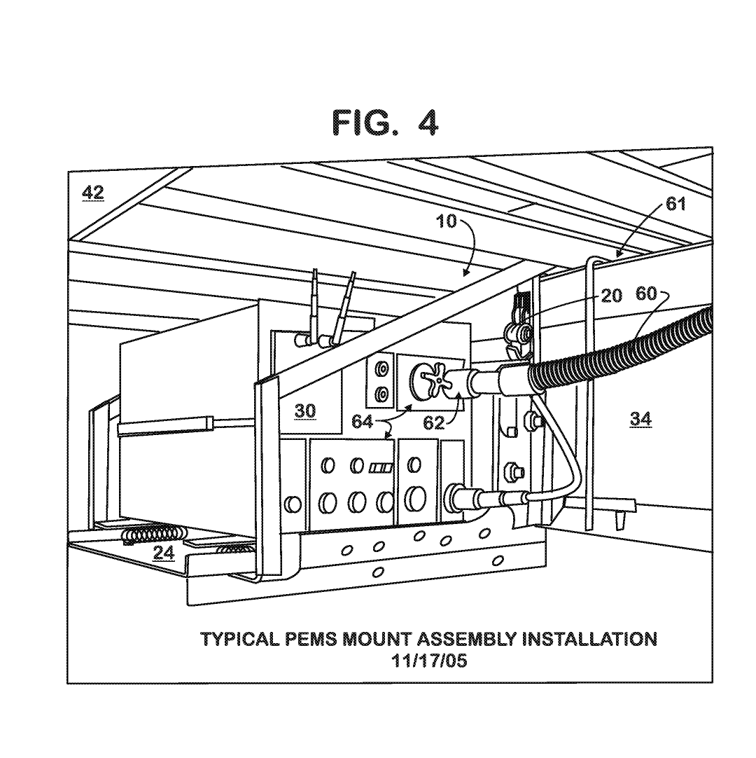

### DESCRIPTION OF THE PREFERRED EMBODIMENT

As iterated above, manufacturers of heavy duty diesel engines must now conduct on-board exhaust emissions tests using customer owned vehicles under normal routes and routines.

An assembly for temporarily mounting a delicate instrument, such as an exhaust emissions analyzer, onto a rail of a truck in order to use the analyzer to conduct in-use emissions tests of vehicles is thus needed. Presently, there is no standardized way of attaching, in a required location, the instrument to a truck chassis or frame. Sensitive instruments, such as an exhaust emission analyzer, are very expensive and sensitive to surrounding ambient conditions. Mounting of an analyzer near the engine exhaust outlet, such as near the tailpipe, is required to allow quick, efficient changeover between the various available configurations when performing emissions tests on vehicles powered by a diesel engine. Such analyzers, equipment and ancillaries are commonly referred to as PEMS—Portable Emissions Measurement System.

An assembly comprising essentially a vibration isolation platform, brackets and hangers has now been devised to accommodate such need.

Referring now to the drawings in greater detail, there is illustrated in the Figures the universal instrument truck mount assembly generally identified by the reference numeral 10.

As shown, a prototype of the assembly 10 comprises two basic angle or L shape brackets 12 of a standard production vehicle battery box mount (not shown), hooks or hangers 14, at a top end 16 of each bracket 12 extending in a direction away from a bottom flange 18 of each angle bracket 12. Straps 20 for securing the assembly 10 and brackets 21 which accommodate a vibration isolation plate or platform 24 of the assembly 10 are also provided. The vibration isolation plate 24 is a critical element of the assembly 10 that must be used when mounting an instrument 30, here an exhaust emission analyzer 30, to prevent damage to its sensitive internal components.

The proposed assembly 10 is sized and configured to allow the analyzer 30 to be securely placed onto a longitudinal body rail 32 or chassis frame rail 34 of a typical medium or heavy duty truck at a desired position, in proximity to an exhaust outlet of an engine of the truck, and under a cab 42 thereof, for reasons set forth in detail herein.

The assembly 10 may be positioned at any of a number of locations along a fore-aft extension of rail 32 without interference from, or introducing obstacles to, other frame located hardware or truck body components, such as the overlying cab 42.

Installation of the assembly 10 is inherently meant to be temporary. The assembly 10 of the present invention accomplishes this end by being easily set in place, secured by straps 20, then removed after testing. No body rail 32 or frame rail 34 modification or special tools are required for installation

The assembly 10 is configured to fit current and past model year truck frame rails 32, 34 of various manufacturers, making it extremely versatile and substantially universal.

The prototype further includes additional brackets 21 fitted to the production angle brackets 12 which allow the isolation plate 24 to be attached to the angle brackets 12. J-shaped hooks or hangers 14, preferably fashioned from tubular steel, extended vertically from the top end 16 of each angle bracket 12, allowing the entire mount assembly 10 to be hung on a body rail 32 or chassis frame rail 34 on either side of the chassis. Also, preferably, standard 1.5″×1.5″ angle iron 50 is engaged to and between the horizontal bottom flange 18 and the top end 16 of each angle bracket 12 to act as a load balance offset for the isolation plate 24 and a cross member 51 extends between the brackets 12.

The mount assembly 10 is held securely to the frame rail 34 using ratcheting or spring grip fabric tie down straps 20. A lower end 52 of each strap 20 is fitted with a U-shaped clasp 54 that is attached to it with a pin 56 and clevis 58. The clasp 54 is used to grasp a lower lip 59 of rail 32, 34 and, when tightened, securely fastens the mount assembly 10 to and against the rail 32, 34.

The mount assembly 10 provides flexiblity in placement or location. The physical dimensions of the prototype accommodate a de-facto industry standard emissions analyzer 30, known as a SEMTECH D, and its corresponding isolation plate 24. By placing the analyzer 30 along a frame rail 34 under the overhang of the truck body or cab 42 the analyzer 30 is partially protected from excess road spray and the elements of weather during on board testing. Additionally, such positioning reduces the likelihood of the analyzer 30 being struck by objects on the side of the truck 36 or of it striking objects, persons or passersby.

Proximity to the exhaust outlet of the engine of the truck is an important consideration when locating the analyzer 30 because a heated sample line 60 used to transport the raw exhaust from the engine to the analyzer 30 must be atttached to the exhaust outlet and then connected to an inlet 62 of the analyzer 30. The length of the heated sample line 60 is limited to 10′-12′, making positioning of the assembly 10 critical.

This assembly 10 accommodates this critical positioning. Physical attributes of overall dimensions, weight and construction are important due to the requirement that the assembly 10 clear the overhead space under the truck body or cab 42 and still be able to support an 80 lb instrument. Thus the instrument 30 engaged on assembly 10 should not be elevated above a top surface 61 of the rail 32,34. Gusseting and reinforcement bars or brackets 50 are incorporated into the design to support the cantilevered weight of the entire assembly 10 but still allow access to front and rear panel connections 64 and 66 of the analyzer 30.

Installing the mount assembly 10 only requires one person to lift and set it in place at a desired location along the rail 32, 34.

The prototype embodiment for accomodating the SEMTECH-D has an assembled weight of approximately 70 lbs. and is approximately 26 inches long and wide, and 21 inches high.

Some of the basic inherent advantages of the assembly 10 are as follows: Expedient analyzer 30 or instrument 30 installation and removal. Provides flexiblity in frame or undercarriage locations. Multiple uses for a variety of portable instruments 30 or ancillary devices which require only temporary mounting. Does not interfere with proximate chassis components. Negates the need to remove or relocate other chassis parts. Does not require tool driven fasteners to install, e.g., no nuts or bolts to hold in place.

Further, it will be understood that the mount assembly 10 is expandable in size because the isolation plate 24 is not fitted to a permanent “floor” on the horizontal expanse of the assembly 10. By simply adding plates 24 or strips of material 50 of different length between the left and right side support or angle brackets 12, the assembly 10 can be increased in width or depth to accommodate larger instruments 30, and similarly, it can be reduced in size by opposite reconfiguration.

As described above, the assembly 10 of the present invention provides a number of advantages, some of which have been described above and others of which are further inherent in the invention. Accordingly, the scope of the invention is only to be limited as necessitated by the accompanying claims.

1. An universal instrument truck mount assembly for use in supporting an engine exhaust analyzer off rails of a truck, in a manner to fit under a cab of the truck, at a desired position, comprising two end hangers which are L shaped, having a J shaped hook at a free top end thereof; each of the hangers supporting one opposite end of a vibration isolation platform sized and configured to receive a corresponding engine exhaust analyzer thereon, and at least one cross member extending between and joining the two end brackets together.

2. An universal instrument truck mount assembly comprising a pair of spaced apart L shaped brackets having a hook at a top end thereof sized and configured to securely engage over a body rail of a truck, each bracket having a horizontal flange extending outwardly from a bottom end thereof, in a direction opposite the hook, each flange being adapted to engage an end edge of an isolation plate sized and configured to support a corresponding instrument thereon, the brackets being engaged to one another by at least one cross rail, with the assembly being sized and configured to compactly hold the instrument to the body rail of the truck at a desired position without interfering with any truck structures proximate thereto.

3. The mount assembly of claim 1 having angle iron welded between the upright and the horizontal leg of the bracket for added support.

4. The mount assembly of claim 1 having an adjustable strap engaged to each bracket and adapted to engage each bracket to a rail of the chassis or frame from which the mount assembly depends.

5. The mount assembly of claim 1 being sized and configured to depend from a chassis rail between frame rails and depending there from in a manner so as not to interfere with overlying truck body structures.

6. The mount assembly of claim 1 being engaged to a rail at a position within proximity to an exhaust outlet of an engine exhaust system of a truck.

7. The mount assembly of claim 1 wherein the isolation plate is sized to support a corresponding horizontally sized instrument.

8. The mount assembly of claim 1 wherein the uprights of the brackets of the mount assembly are sized to accommodate a vertical extent of a corresponding instrument so as to maintain the vertical extent thereof below an upper edge of the rail from which the mount assembly depends.

9. The mount assembly of claim 2 having angle iron welded between the upright and the horizontal leg of the bracket for added support.

10. The mount assembly of claim 2 having an adjustable strap engaged to each bracket and adapted to engage each bracket to a rail of the chassis or frame from which the mount assembly depends.

11. The mount assembly of claim 2 being sized and configured to depend from a chassis rail between frame rails and depending there from in a manner so as not to interfere with overlying truck body structures.

12. The mount assembly of claim 2 being engaged to a rail at a position within proximity to an exhaust outlet of an engine exhaust system of a truck.

13. The mount assembly of claim 2 wherein the isolation plate is sized to support a corresponding horizontally sized instrument.

14. The mount assembly of claim 2 wherein the uprights of the brackets of the mount assembly are sized to accommodate a vertical extent of a corresponding instrument so as to maintain the vertical extent thereof below an upper edge of the rail from which the mount assembly depends.

15. An universal instrument truck mount assembly for use in supporting an engine exhaust analyzer off rails of a truck, in a manner to fit under a cab of the truck, near an exhaust outlet of an engine of the truck comprising two end hangers which are L shaped, having a J shaped hook at a free top end thereof; each of the hangers supporting one opposite end of a vibration isolation platform sized and configured to receive a corresponding engine exhaust analyzer thereon, and at least one cross member extending between and joining the two end brackets together.
